(19) United States
(12) Patent Application Publication
(10) Pub. No.: US 2014/0227424 A1
(43) Pub. Date: Aug. 14, 2014

(54) METHOD OF PRODUCING ANIMAL FEED AND OTHER PRODUCTS CONTAINING LIGNIN DERIVATIVES

(71) Applicant: Kenneth Hillel Peter Harris, Asker (NO)

(72) Inventor: Kenneth Hillel Peter Harris, Asker (NO)

(73) Assignee: Zilkha Biomass Fuels I LLC, Houston, TX (US)

(21) Appl. No.: 14/177,068

(22) Filed: Feb. 10, 2014

Related U.S. Application Data
(60) Provisional application No. 61/762,624, filed on Feb. 8, 2013.
(60) Provisional application No. 61/888,905, filed on Oct. 9, 2013.

(51) Int. Cl. A23K 1/14

(52) U.S. Cl. CPC A23K 1/146
USPC 426/635; 426/511

(57) ABSTRACT

Various embodiments of the disclosure are directed to a method of producing a lignocellulose-based product. A biomass having up to 65% by weight of moisture prior to steam treatment is treated with steam in a reactor. A sulfite is provided to the reactor. A lignocellulose-based product is produced.

### CROSS-REFERENCE TO RELATED APPLICATIONS

The present application claims the benefit under 35 U.S.C. §119(e) of U.S. Provisional Application Ser. No. 61/762,624, filed Feb. 8, 2013, entitled “Animal Feed and Other Products Containing Water-Soluble Lignin Derivatives”, and U.S. Provisional Application Ser. No. 61/888,905, filed Oct. 9, 2013, entitled “Animal Feed and Other Products Containing Solubilized or Plasticized Lignin Derivatives” which are hereby expressly incorporated herein in their entirety.

### BACKGROUND

Various embodiments of the present disclosure are generally directed to a cost-effective method of refining lignocellulosic materials by steam processing them together with a catalyst in a previously evacuated reactor. The method can be used to make animal feed having high digestibility that contains its own binder and cellulose fibers for paper and other applications.

The high price of fossil fuels and the worldwide interest in replacing products that are totally dependent upon fossil fuels, such as gasoline diesel fuel, has led to a demand for other fuels, such as bioethanol and biodiesel that are less expensive. These are typically based crops otherwise used for food and animal feed such as sugar/molasses, maize, wheat, soybeans, etc., which has led to a considerable increase in the demand for and price of these commodities. The price of some of them, particularly corn and other grains, is also strongly influenced by the harvest, which means weather conditions in the major growing areas.

This is the situation that various embodiments of the present invention is intended to rectify by offering a low cost route to make animal feed of high digestibility and cellulose fibers having low lignin contents for conversion to bioethanol from biomass that cannot be used for food or feed, such as wood, straw, bamboo, bagasse, etc.

The use of steam treatment to convert biomass that has been pretreated with sulfur dioxide or sulfuric acid to useful products, including animal feed, is described in the literature but yields are low, the risk of degradation high, and the process is difficult to control. Furthermore, the method is quite unsuitable for softwoods. Work has also been carried out on the manufacture of fibers using steam treatment of deciduous wood chips that have been impregnated with a mixture of sodium hydroxide and sodium sulfite. These fibers have only limited application because they are considered too short for many uses, such as kraft papers, and because their residual lignin and hemicellulose contents are too high for them to be economically bleached to make dissolving grade cellulose or writing and printing papers.

The use of hydrolysis with steam or hot water at temperatures above 150° C. to break lignocellulose down into its constituent parts is also well-known from the literature, although these methods are typically restricted to use with xylan-rich plants such as deciduous wood and annual crop residues. Most of these entail two processing steps. One approach for lignin-rich materials is to slurry the raw material in water, heat the whole to 200° C. or more, remove the hydrolyzed hemicellulose sugars which would otherwise interfere with the subsequent lignin/cellulose processing, then heat the whole at higher temperatures to hydrolyze the cellulose to glucose. These are extremely energy-intensive and require long processing times. The equipment is expensive because of the high pressures involved and because the hemicellulose sugars are present as a dilute solution which cannot be released to the environment and must be processed further, e.g., by concentration or waste water treatment.

Other approaches hydrolyze the hemicellulose to sugars which are removed, followed by delignification with alkali or active oxygen to remove lignin. These require expensive chemicals and would, if they were ever to be used commercially, necessitate investment in chemical recovery and/or waste water treatment.

Another approach utilizes a conventional acid sulfite pulping plant, heating to 150-160° C. a dispersion of biomass, which can be softwood chips, in 15-20 times its weight of water for several hours to make lignosulphonates, fermentable sugars and cellulose suitable for use as a basis for bioethanol. Since these plants operate at low pH values, typically between 1.5 and 2.5, they require frequent maintenance because of corrosion; they also require waste water treatment to, and a method for reclaiming excess pulping chemicals, in particular, sulfur dioxide added during pulping. This, and their high capital cost and energy demand, means they cannot manufacture cellulose fibers or animal feed products at a competitive price and most have closed down.

Therefore, a need exists to produce animal feed or other products having high digestibility and addressing the problems as described herein. The present disclosure is directed to at least one method of producing such animal feed and other products containing lignin derivatives.

### DETAILED DESCRIPTION

The present disclosure is directed to various embodiments of methods which entail stream treating undried solid-state biomass containing sulfites, the term being used herein to include bisulfites, a mixture of sulfites and bisulfites or sulfites alone or in combination with a base which can also be accompanied by sulfur dioxide injection or a lignin solvent, or swelling agent of boiling point >100° C. in a previously evacuated reactor. The use of a base or alkaline substance works to maintain an exit pH of between 2.0 and 4.5. Because biomass is treated in solid form means that all the products are present in high concentration.

Various advantages of the methods compared to state of the art steam treatment is that the rate of lignin hydrolysis is increased relative to the rate of hemicellulose hydrolysis, thus reducing the degradation of acid sensitive materials, such as C₅ sugars generated from hemicelluloses. In one embodiment a sulfite is added to the biomass raw material, which may contain up to 65%, up to 55%, up to 45%, up to 35%, up to 25% by weight moisture, such that a proportion of the lignin is converted to water soluble lignosulfonates during steam treatment.

In another embodiment, a substance such as an oil or a polyhydric alcohol that is miscible with the lignin at steam temperature is added to the raw material.

When these additives are not used, the so-called “native” lignins that are formed during steam treatment can react with the sugars to form crosslinked, insoluble pseudolignin, particularly at low pH and when undried biomass is used. When sulfites are used, but the reactor not evacuated, the pH falls rapidly, leading to the degradation of sugars and formation of pseudolignin. This is, to a certain extent, avoided in the acid sulfite pulping process, but at the cost of using large amounts of water which, inter alia, reduce the concentration of the hydrolysis products.

The stability of the systems described herein means that the amount of undesirable by-products formed, such as furfural, is very low even over a wide range of temperatures. This suggests that the removal of most of the oxygen present in the reactor is important because evacuation of the reactor removes oxygen that might otherwise have oxidized the bisulfites to far more acidic bisulfates.

Furthermore, when sulfites are used the lignin is effectively removed from the surface of the cellulose fibers into aqueous solution, rather than remaining on them as insoluble droplets, as is the case with conventional so-called steam explosion processing. This has obvious benefits in improving the digestibility of animal feed, where lignin acts as a barrier to rumen microbes, but also has the twin benefits of permitting softwoods to be processed thoroughly to low residual lignin levels whilst enabling steam processing to be carried out at lower temperatures so that the cellulose fibers are not degraded. This makes it possible to produce easily bleached cellulose fibers suitable for chemical and paper applications.

The steam treated materials made in accordance with this embodiment contain two types of components: an aqueous fraction containing lignosulfonates and alkali and alkaline earth metal derivatives from the ash and organic materials, primarily carbohydrates and an insoluble residue containing primarily cellulose, together with small amounts of ash, for the most part, silica.

The aqueous fraction can be left in the product to yield a high value animal feed that, because of its content of lignosulfonates, contains its own binder. The binder itself has sought-after properties as an additive that protects protein in the rumen whilst at the same time enabling other feed additives such as a protein source, to be added in an eventual pelletizing operation.

In another embodiment, the aqueous fraction can be removed and used as a combined energy source and binder, together with solid materials such as minerals, milled corn, soybean meal, etc., animal feed products.

The aqueous fraction can also be separated, e.g., by reverse osmosis, into fractions of high and low molecular weight. The latter, mainly carbohydrates, can be used as a raw material for making chemicals such as xylitol and furfural or as a fermentation feedstock for making bioethanol, biogas, etc., depending upon the biomass that has been processed. The former, primarily lignosulfonates, can be used as a binder, with or without further fractionation by molecular weight, or as a chemical feedstock, e.g., in the production of vanillin.

In at least one embodiment, lignocellulose-based products are made by steam treating an undried biomass containing up to 60% moisture and, in another embodiment, between 15 and 30% moisture, and at least 2% of a sulfite by weight of biomass dry matter, contained in a previously evacuated vessel and, optionally, up to 2% of sulfur dioxide on weight of biomass dry matter.

In another embodiment, the vessel containing the biomass is evacuated before the introduction of steam, such that the total free oxygen content of the gas in the vessel into which the steam is injected is between 3 volume % and 10 volume %. The lignocellulose-based products from biomass are treated by injecting dry saturated or unsaturated steam having a temperature of at least 150° C. at a pressure of at least 60 psig and in one embodiment between 120 and 240 psig into a vessel containing the biomass and maintaining the chosen pressure for between 2 and 30 minutes, the lower the steam pressure, the longer the residence time.

The sulfite is chosen from calcium, magnesium, sodium or potassium sulfite added as a powder or solution to the raw material or injected as a solution into the evacuated vessel prior to the introduction of steam.

Any sulfur dioxide added as co-catalyst is added as a gas or solution into the evacuated vessel prior to the introduction of steam.

Animal feed products containing their own binders made by adding a finely divided alkaline material, by way of example, calcium hydroxide or calcium carbonate, to the steam treated material following its removal from the reactor vessel and before it is fed to the animal, such that its pH value is increased to between 5.5 and 7.5, in one embodiment, and to between 7.0 and 8.5 in another embodiment.

Easily bleached cellulose fiber products with low residual lignin contents suitable for use in fiber and chemical applications, which can be based upon mixed species, made by washing the steam treated material to remove lignin and hemicellulose derivatives.

In another embodiment, lignin-miscible oils or polyhydric alcohols are added to the raw materials. This causes the lignin to swell and become more prone to hydrolysis during steam treatment, while the slowing the rate of hemicellulose hydrolysis and the formation of reactive sugars that can participate in the formation of pseudolignin. These additives also cause the lignin to melt and become thermoplastic at a lower temperature than if they are not used, which is a distinct advantage when making, e.g., animal feed pellets where high pelletizing temperatures need to be avoided to minimize the formation of undesirable by-products.

In order to further illustrate various embodiments of the present disclosure, the following examples are given. However, it is to be understood that the examples are for illustrative purposes only and are not to be construed as limiting the scope of the subject invention.

### EXAMPLES

### The Manufacture of Animal Feed Products Using a Sulfite Catalyst

### 1.1. Processed Biomass Containing its Own Binder for Use as Pelletized Animal Feed

### Raw Material:

100 parts by weight of chopped or pelletized wheat straw

4 parts of sodium sulfite, which may be contained in the pellets

Optionally up to 4 parts of finely divided calcium carbonate which may be contained in the pellets

### Processing in the Reactor

The moisture content of the wheat straw or pellets is adjusted to a maximum of 15% by weight, following which they are transferred to a reactor. The whole is evacuated to −0.85 bar with a vacuum pump and allowed to stand for 2 minutes. The vacuum pump is switched off and dry saturated steam having a temperature of 180° C. is introduced and the whole allowed to stand for 8 minutes once a pressure of 9 bar is reached and maintained. The steam treated biomass is removed from the reactor vessel and dried to 20% moisture content by weight.

### Pellet Manufacture

100 parts by weight (pbw) of steam treated material is mixed with sufficient finely divided calcite or calcium hydroxide to bring the pH of a 10% by weight suspension in water up to at least 5.5 and in one embodiment, 6.5-7.5. The moisture content of the mixture is corrected to about 15% by weight and the whole pelletized in a mill equipped, ensuring that the pellet temperature does not exceed 105° C. Pelletizing properties can be enhanced by the addition of up to 5% urea, which also functions as a protein source.

### 1.1.1. Processed Biomass Containing its Own Binder for Use as Pelletized Animal Feed

### Raw Material:

100 parts by weight of chopped or pelletized wheat straw

### Processing in the Reactor

The wheat straw or pellets are transferred to the reactor without drying, if necessary, with water added to bring their moisture content up to the 15% on biomass dry weight. The whole is evacuated to −0.85 bar and allowed to stand for 2 minutes. The vacuum pump is switched off and a solution of calcium bisulphite added through a valve in the base of the reactor in an amount equivalent to 7 parts by weight of biomass dry matter. Dry saturated steam having a temperature of 180° C. is introduced and the whole allowed to stand for 8 minutes once a pressure of 9 bar is reached and maintained. The steam-treated biomass is removed from the reactor vessel and dried to 20% moisture content.

### Pellet Manufacture

100 parts dry weight of steam-treated material is mixed with 5 parts of calcium hydroxide and 20 parts dry weight of DDGS and water added such that the moisture content of the mixture is about 15% and the whole pelletized in a mill equipped with a 18 mm die, ensuring that the pellet temperature does not exceed 95° C.

### 1.2. Use of the Water-Soluble Components as Rapid Energy Source and Binder in Animal Feed Following the Use of a Sulfite Catalyst

Where the steam treated product is to be used to make cellulose fibers as described herein, the water soluble components are separated. These will consist of a mixed solution of lignosulfonate and hemicellulose sugars, the relative proportion being dependent upon the species being processed. The prior art contains many references to the value of free hemicellulose sugars as animal feed and to the use of lignosulfonates as binders in making animal feed pellets. This makes the combination of these components extremely useful as a combined rapid energy source and binder.

### Product Manufacture and Use

Material treated in accordance with 1.1 or 1.2 is washed, and the aqueous liquor removed. The solids content of this aqueous phase consists of between 35%-60% by weight carbohydrates and between 25%-50% by weight lignosulfonates. The product can be used as it is, concentrated, e.g., by reverse osmosis or (vacuum) evaporation or by spray drying.

The resulting product is well suited as a combined rapid energy source and binder for use in making compound feed pellets, replacing the binders and any rapidly available energy source molasses otherwise used together with some of the corn or other energy constituents in the ration.

### 2. The Manufacture of Cellulose Fibers Using a Sulfite Catalyst

Three types of cellulose fibers are made by following the method of this disclosure as described herein: i) fibers for paper; ii) fibers for chemical applications such as rayon and cellulose ester manufacture and iii) fibers used as raw materials for bioethanol manufacture. It is a unique advantage of the method described herein that i) and ii) can be based upon softwood or hardwood, or mixtures of the two, whereas iii) is suitable for any lignocellulosic feedstock. The water soluble hemicellulose derivates are removed together with the lignosulfonates by a washing procedure.

### 2.1. Cellulose Fibers for Paper Manufacture Using a Sulfite Catalyst

### Raw Material

100 parts by weight of fresh, softwood cellulose chips

3 parts of sodium sulfite

2 parts of sodium metabisulfite

Optionally up to 6 parts of finely divided calcium carbonate which may be contained in the pellets

### Processing in the Reactor

The wood-chips and sulfites and any calcium carbonate are mixed and transferred to the reactor without drying. The whole is evacuated to −0.85 bar and allowed to stand for 2 minutes. The vacuum pump is switched off and dry, saturated steam having a temperature of 160° C. is introduced and the whole is allowed to stand for 15 minutes once a pressure of 5.2 bar is reached and maintained.

### Water Washing Procedure

The steam treated biomass is removed from the reactor vessel and the fibrous material is removed and can be bleached before subsequent use.

2.2. Cellulose Fibers for Dissolving Grade Cellulose Using a Sulfite Catalyst

Cellulose that is to be used for chemical applications can be made from softwood chips by the method of this invention, but it is particularly advantageous, especially where the cellulose is to be dissolved and used to make fibers such as rayon, to use the method to process a mixture of softwood and hardwood chips. This produces cellulose with a broad molecular weight distribution and improved fiber manufacturing characteristics. It is often impracticable to process these raw materials together in a conventional pulping process.

### Raw Material

80 parts by weight of fresh, softwood cellulose chips, 20 pbw fresh hardwood cellulose chips.

4 pbw of sodium sulfite on dry matter

2 pbw of sodium metabisulfite on dry matter

At least 1 part of calcium carbonate

### Processing in the Reactor

The wood-chips and sulfites and any calcium carbonate are mixed and transferred to the reactor without drying. The whole is evacuated to −0.85 bar and allowed to stand for 2 minutes. The vacuum pump is switched off and dry, saturated steam having a temperature of 160° C. is introduced and the whole is allowed to stand for 15 minutes once a pressure of 5.2 bar is reached and maintained.

### Water Washing Procedure

The steam treated biomass is removed from the reactor vessel and the fibrous material is removed and can be bleached before subsequent use.

### 2.3. Cellulose for Bioethanol Manufacture Using a Sulfite Catalyst

Cellulose used in bioethanol manufacture via enzymatic hydrolysis to glucose needs to be essentially free of lignin; if it is to be processed by acid hydrolysis, of hemicellulose as well. It is also advantageous to produce cellulose of low molecular weight, either by using a raw material such as a partially dried food processing waste or an annual crop residue consisting of short fibers and/or by processing the raw material such that the cellulose itself starts to hydrolyse, but without any concomitant degradation of the other components. In at least one embodiment, the product is washed to remove hydrolyzed hemicellulose and lignosulfonates before the fibers are used to make glucose and bioethanol. Conventional techniques typically employ some form of alkali wash and/or a bleaching stage to remove sufficient lignin for the cellulose to be hydrolysed efficiently. These are expensive post-treatment processes that also entail some form of waste water treatment; they are unnecessary when the method of this invention is followed. At least one embodiment of the method as disclosed herein permits this to be done, as the following example demonstrates.

### Raw Material

100 parts by weight of fresh, wheat straw, pelletized.

3 pbw on dry matter sodium sulfite, 2pbw dry matter of sodium metabilsulfite and up to 4 pbw of calcium carbonate, contained in the pellets.

### Processing in the Reactor

The wheat straw or pellets are transferred to the reactor without drying. The whole is evacuated to −0.85 bar and allowed to stand for 2 minutes. Dry saturated steam having a temperature of 200° C. is introduced and the whole allowed to stand for 6 minutes once a pressure of 14.5 bar is reached and maintained.

### Water Washing Procedure

Material is washed, and the aqueous liquor removed.

The washed product can be used as such without further processing but it is advantageous to wash it first to remove lignin and hemicellulose sugars that can be used separately, e.g., in animal feed.

### 2.3.1. Cellulose for Bioethanol Manufacture

### Raw Material

100 parts by weight of fresh, wheat straw, preferably pelletized.

### Processing in the Reactor

The wheat straw is transferred to the reactor without drying; if necessary, water is added to bring its moisture content up to 15%. The whole is evacuated to −0.85 bar and allowed to stand for 2 minutes. The vacuum pump is switched off and 14 parts by weight of biomass dry matter of a concentrated (500 g/l) solution of sodium metabisulphite (Na₂S₂O₅) added through a valve in the base of the reactor. Dry saturated steam having a temperature of 200° C. is introduced and the whole allowed to stand for 6 minutes once a pressure of 14.5 bar is reached and maintained.

### Water Washing Procedure

As per 1.1.

The washed product can be used as such without further processing.

### 3. Products Made Using a Lignin Swelling Agent

### 3.1. Animal Feed

### Raw Material:

100 parts by weight of chopped or pelletized wheat straw

3 pbw of canola oil, which may advantageously be contained in the pellets

### Processing in the Reactor

The moisture content of the wheat straw or pellets is adjusted to maximum 15%, following which they are transferred to the reactor. The whole is evacuated to −0.85 bar and allowed to stand for 2 minutes. The vacuum pump is switched off and dry saturated steam having a temperature of 180° C. is introduced and the whole allowed to stand for 8 minutes once a pressure of 9 bar is reached and maintained. The steam treated biomass is then removed from the reactor vessel.

### Pellet Manufacture

100 pbw of steam treated material is mixed with sufficient finely divided calcite or calcium hydroxide to bring the pH of a 10% bw suspension in water up to at least 5.5, and in one embodiment 6.5-7.5. The moisture content of the mixture is corrected to about 15% and the whole pelletized in a mill equipped, ensuring that the pellet temperature does not exceed 105° C. Pelletizing properties can be enhanced by the addition of up to 5% by weight of urea, which will also function as a protein source.

### 3.2.-3.4. Paper Fibers, Cellulose for Bioethanol, Dissolving Grade Cellulose

In at least one embodiment, lignin swelling agents can replace the sulfites used in 2.1.-2.3. and then following the procedures described therein. However, the fibers thus obtained are washed with an alkali, e.g., sodium hydroxide, in order to remove the lignin, which is made to a very great extent, easily soluble in this substance due to the action of the lignin swelling agent. This means that products made thus can easily be adapted to a pulp plant using a sulphate or soda process.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed:

1. A method of producing animal feed, comprising:
providing a biomass having between 0% to 65% by weight of moisture;
introducing steam into a reactor containing the biomass;
providing a sulfite to the reactor; and
forming the treated biomass into pellets for animal feed.

2. The method of claim 1 wherein the sulfite is a bisulfite.

3. The method of claim 1 wherein the sulfite is a mixture of sulfites and bisulfites.

4. The method of claim 1 wherein the sulfite includes an alkaline substance.

5. The method of claim 1 wherein at least 2% by weight of sulfite is provided.

6. The method of claim 1 further comprising:
evacuating the reactor prior to introducing the steam.

7. The method of claim 6 wherein the total free oxygen content of the gas in the reactor is between about 3 volume % and 10 volume %

8. The method of claim 6 further comprising:
injecting sulfur dioxide into the evacuated reactor.

9. The method of claim 8 wherein 0% to 2% by weight of sulphur dioxide is provided.

10. The method of claim 6 further comprising:
injecting a swelling agent into the evacuated reactor.

11. The method of claim 10 wherein the swelling agent has a boiling point of greater than 100° C.

12. The method of claim 1 wherein the temperature of the steam is at least 150° C.

13. The method of claim 1 wherein the pressure of the steam is at least 60 psig.

14. The method of claim 1 further comprising:
maintaining the pressure for between 2 and 30 minutes.

15. The method of claim 1 further comprising:
washing the treated biomass.

16. The method of claim 16 further comprising:
removing and aqueous phase from the treated biomass.

17. The method of claim 16 wherein the aqueous phase includes between 35% to 60% by weight of carbohydrates and between 25% and 50% lignosulfonates.

18. The method of claim 1 wherein the surface temperature of the pellets is less than 105° C.

19. The method of claim 1 further comprising:
adding between 0% and 5% by weight of urea to the pellets.

20. The method of claim 1 further comprising:
mixing an alkaline material with the treated biomass.
